(19) United States
(12) Patent Application Publication
(10) Pub. No.: US 2024/0182011 A1
(43) Pub. Date: Jun. 6, 2024

(54) ELECTROPNEUMATIC BRAKE SYSTEM, VEHICLE, METHOD FOR OPERATING AN ELECTROPNEUMATIC BRAKE SYSTEM, WITH AN EMERGENCY RELEASE VALVE UNIT

(71) Applicant: ZF CV Systems Global GmbH, Bern (CH)

(72) Inventor: Julian van Thiel, Grossburgwedel (DE)

(21) Appl. No.: 18/443,085

(22) Filed: Feb. 15, 2024

Related U.S. Application Data
(63) Continuation of application No. PCT/EP2022/071542, filed on Aug. 1, 2022.

(30) Foreign Application Priority Data
Aug. 31, 2021 (DE) 10 2021 122 499.3

(51) Int. Cl. B60T 13/38; B60T 8/17; B60T 8/171; B60T 13/68; B60T 17/08; B60T 17/18

(52) U.S. Cl. CPC B60T 13/385; B60T 8/1708; B60T 8/171; B60T 13/683; B60T 17/083; B60T 17/18; B60T 2270/402; B60T 2270/414

(57) ABSTRACT

An electropneumatic brake system for a vehicle has a parking brake system having a parking brake valve unit constructed to adjust a parking brake pressure on at least one spring loading connection in accordance with a pilot control pressure. The valve unit has a pilot control unit which in accordance with an electronic parking brake signal adjusts the pilot control pressure on a pilot control path. The parking brake unit has an additional brake pressure connection which is or can be pneumatically connected to the pilot control path to introduce an emergency release pressure. The introduction of the emergency release pressure on the additional brake pressure connection causes the adjustment of the parking brake pressure on at least one spring loading connection. A first control unit is configured to provide the electronic parking brake signal to the valve unit. The electropneumatic brake system can have an emergency release valve unit.

### CROSS-REFERENCE TO RELATED APPLICATIONS

This application is a continuation application of international patent application PCT/EP2022/071542, filed Aug. 1, 2022, designating the United States and claiming priority from German application 10 2021 122 499.3, filed Aug. 31, 2021, and the entire content of both applications is incorporated herein by reference.

### BACKGROUND

In electropneumatic brake systems for modern vehicles, safety concepts are highly relevant. In particular with vehicles having automated or partially automated driving functions, concepts for the activation of an emergency braking operation in the event of a malfunction or a power failure of a control unit make a significant contribution to the safety of the vehicle, its passengers and other road users. Such concepts enable a safe stopping of the vehicle in the event of a malfunction or a power failure.

There are advantageously already such concepts which implement an emergency braking operation via a parking brake system. In particular, such an emergency braking operation is carried out via venting at least one spring-loaded brake cylinder, which results in application of the at least one spring-loaded brake cylinder and a corresponding emergency braking operation.

Thus, DE 10 2019 131 930 A1 describes, for example, an electropneumatic parking brake module for an electronically controllable pneumatic brake system for a vehicle having a storage connection for receiving a storage pressure, at least one parking brake connection for connecting at least one parking brake cylinder, a main valve unit which receives the storage pressure and which is constructed in accordance with a control pressure to adjust a spring loading pressure at the parking brake connection, and a pilot valve arrangement which receives the storage pressure in order to provide the control pressure, wherein the pilot valve arrangement has a retention valve which opens in a powerless manner and a bistable valve which can be switched between a first aeration and a second venting position. According to the approach disclosed in DE 10 2019 131 930 A1, as a result of the retention valve which opens in a powerless manner in the event of a malfunction or a power failure, by independently venting the control pressure an emergency braking operation can be produced.

It is further problematic to produce a roadworthy state of a vehicle after an emergency braking operation has been completed. Generally, to this end, an emergency release pressure has to be introduced in order to achieve an aeration of the at least one applied spring storage brake cylinder. Such an introduction of the emergency release pressure generally requires a relatively high level of expenditure in terms of time and/or equipment and in particular a manual intervention.

It is therefore desirable to improve the release of a parking brake system. In particular, the provision of an emergency release pressure is intended to be enabled in a reliable manner and with little complexity.

### SUMMARY

It is an object of the disclosure to provide an improved electropneumatic brake system which enables the improved provision of an emergency release pressure.

The object is achieved by the disclosure in a first aspect with an electropneumatic brake system. The disclosure is based on an electropneumatic brake system for a vehicle, preferably a utility vehicle, having a parking brake system having a parking brake valve unit which is constructed to adjust a parking brake pressure on at least one spring loading connection in accordance with a pilot control pressure, wherein the parking brake valve unit has a pilot unit which adjusts the pilot pressure on a pilot path in accordance with an electronic parking brake signal. The parking brake valve unit has an additional brake pressure connection which is or can be pneumatically connected to the pilot path in order to introduce an emergency release pressure, wherein the introduction of the emergency release pressure at the additional brake pressure connection brings about the adjustment of the parking brake pressure on at least one spring loading connection. The electropneumatic brake system further has a first control unit which is constructed to provide the electronic parking brake signal to the parking brake valve unit.

According to the disclosure, the electropneumatic brake system is characterized in that it has an emergency release valve unit. The emergency release valve unit is constructed to receive a service brake pressure which is provided by a service brake system and which is effective for a service braking operation or a pressure which is derived from the service brake pressure and in accordance with a received electronic emergency release signal to provide an emergency release pressure at the additional brake pressure connection.

The disclosure is based on the recognition that the provision of an emergency release pressure is advantageous for releasing the spring-loaded brake cylinder, particularly when the vehicle is intended to be moved by the parking brake system after a completed emergency braking operation. The disclosure includes the recognition that the provision of the emergency brake pressure can advantageously be carried out in an electronically controlled manner via an emergency release valve unit which is constructed in accordance with a received electronic emergency release signal to provide an emergency release pressure. In this manner, the manual effort which is otherwise required in order to provide the emergency release pressure in order to release the spring-loaded brake cylinder can be reduced or even avoided.

By a service brake pressure which is effective for a service braking action or a pressure which is derived from the service brake pressure being received and used to provide the emergency release pressure, a system which is independent of the parking brake system can be used to provide the emergency release pressure. This is particularly advantageous when the first control unit and/or the parking brake system is not available as a result of a malfunction or a power failure.

As a result of the use of the service brake pressure or a pressure which is derived from the service brake pressure, it is further advantageously possible for this pressure to be able to be made available to the emergency release valve unit only when the service brake system is also activated. It can thus advantageously be ensured that, as a result of a simple malfunction, for example, in a valve of the emergency release valve unit, the parking brake system or the spring-loaded brake cylinder cannot be unintentionally released.

In a particularly preferred manner, the service brake pressure or the pressure derived from the service brake pressure is provided as emergency release pressure at the additional brake pressure connection. In other further embodiments, the service brake pressure is provided as an emergency release pressure at the additional brake pressure connection by a storage pressure being adjusted by a valve, preferably by a pneumatically controlled main valve, in accordance with the service brake pressure and/or the electronic emergency release signal as an emergency release pressure at the additional brake pressure connection.

In a further embodiment, there is provision for the electronic emergency release signal to be provided by an additional control unit. Preferably, the emergency release valve unit is or can be pneumatically connected to a service brake system. In a particularly preferred manner, the emergency release valve unit has a service brake connection which in order to receive a service brake pressure can be connected to a service brake pressure-guiding portion of the service brake system, in particular an axle modulator. Preferably, the additional brake pressure connection is an emergency release connection. In other further embodiments, the brake pressure connection may alternatively be a different connection, preferably an anti-compound connection.

In a further embodiment, there is provision for the additional control unit to be a service brake control unit which is associated with the service brake system. In such further embodiments, it is advantageously possible for the emergency release valve unit to be able to be activated when the first control unit which is associated with the parking brake system has failed. Such a failure of the first control unit may occur, for example, as a result of a malfunction and/or a power failure.

The disclosure is further developed in that the first control unit is supplied with electrical energy by a first energy supply and the additional control unit is supplied with electrical energy by a second energy supply which is independent of the first energy supply. In such further embodiments, it is advantageously possible for the emergency release valve unit to also be able to be activated by the additional control unit when the first energy supply has failed, for example, since an error which leads to a power failure has occurred in the first energy supply and the first control unit. Preferably, the first energy supply has a first battery and/or the second energy supply has a second battery. In a particularly preferred manner, the first energy supply is a first battery and/or the second energy supply is a second battery.

In the context of a further embodiment, there is provision for the emergency release valve unit to have an emergency release pressure sensor which is constructed to establish the emergency release pressure provided by the emergency release valve unit. Via an emergency release pressure sensor, the function of the emergency release valve unit can be checked. Preferably, the emergency release pressure sensor is pneumatically connected to the main connection of the emergency release valve unit and/or to the first emergency release valve connection. Preferably, the emergency release pressure sensor is formed to provide a corresponding emergency pressure signal, preferably to the additional control unit. Preferably, the emergency release pressure sensor is arranged in the emergency release valve unit and/or the emergency release module or the structural unit.

Advantageously, there is provision for the pilot control unit to be constructed to be pneumatically self-retaining. In a further embodiment, the pilot control unit has a compensation valve between a storage path of the parking brake valve unit and the control path, which can preferably be pneumatically switched via a compensation control connection which is pneumatically connected to the control path. In a particularly further embodiment, the compensation valve is throttled and has a first throttle between a first compensation valve connection and a second compensation valve connection, and/or a second throttle between the second compensation valve connection and a third compensation valve connection. Via a pneumatically self-retaining pilot control unit, in particular via a compensation valve, advantageously via an emergency release pressure which can be introduced once or temporarily, a control connection of the pneumatically activated main valve can be permanently vented since, as a result of the compensation valve, a pneumatic connection between a storage path and the control connection can be produced. The compensation valve is preferably switched via a pneumatic compensation control path. In this manner, the spring-loaded brake cylinder by briefly introducing the emergency release pressure, preferably in the form of a service brake pressure, can be released permanently or over a relatively long period of time. Preferably, the pilot control unit has a first pilot control valve which is constructed to connect the storage path pneumatically to the pilot control path in a controllable manner. Preferably, the pilot control unit has a second pilot control valve which is constructed to connect the pilot control path pneumatically to a venting connection in a controllable manner.

In the context of a further embodiment, there is provision for the emergency release valve unit to have a 3/2-way valve, preferably a 3/2-way solenoid valve. The 3/2-way valve has a first emergency release valve connection for providing the emergency release pressure, a second emergency release valve connection for receiving the service brake pressure or the pressure derived from the service brake pressure, and a third emergency release venting connection. The 3/2-way valve is constructed in a first emergency release valve position to pneumatically connect the first emergency release valve connection to the second emergency release valve connection, and in a second emergency release valve position to pneumatically connect the first emergency release valve connection to the emergency release venting connection. Preferably, the first emergency release valve connection can be pneumatically connected to the additional brake pressure connection. In particular in the first emergency release valve position, the emergency release venting connection is blocked. In particular in the second emergency release valve position, the second emergency release valve connection is blocked. In a particularly preferred manner, the 3/2-way valve is in the form of a solenoid valve which can be controlled in accordance with an electronic emergency release signal.

The disclosure is further developed in that the emergency release valve unit has an emergency release pilot control arrangement which in accordance with the electronic emergency release signal adjusts the service brake pressure or the pressure derived from the service brake pressure as an emergency release pilot control pressure and has an emergency release main valve arrangement which, in accordance with the emergency release pilot control pressure adjusts a storage pressure as the emergency release pressure at the main connection. Preferably, the emergency release valve unit has a storage connection for receiving the storage pressure. Preferably, the emergency release main valve arrangement has a pneumatically switchable main valve. Preferably, the main valve is in the form of a 3/2-way valve having a first main valve connection for providing the emergency release pressure, a second main valve connection for receiving the storage pressure and a third main valve venting connection. Preferably, the main valve is constructed in a first main-valve valve position to pneumatically connect the first main valve connection to the second main valve connection and in a particularly preferred manner to block the main valve venting connection. Preferably, the main valve is constructed in a second main-valve valve position to pneumatically connect the first main valve connection to the main valve venting connection and in a particularly preferred manner to block the second main valve connection.

Preferably, the emergency release valve unit has a pneumatic self-retaining path which pneumatically connects a main valve control connection of the main valve to the main connection of the emergency release valve unit and/or a first main valve connection of the main valve. Via the pneumatic self-retaining path, it is advantageously possible to achieve a pneumatic self-retention by the emergency release valve unit via which a briefly introduced service brake pressure leads to a permanent provision of an emergency release pressure. In this manner, the at least one spring-loaded brake cylinder after the service brake pressure or the pressure derived from the service brake pressure has been introduced once can be permanently released.

Preferably, there is provision for the emergency release pilot control arrangement to have a pilot control valve which can be controlled via the electronic emergency release signal. In a particularly preferred manner, the pilot control valve is in the form of a 2/2-way valve, preferably a 2/2-way solenoid valve.

The disclosure is further developed in that the emergency release pilot control arrangement has a retention valve which is constructed to selectively retain the emergency release pilot control pressure, in particular at the main valve control connection, in accordance with the emergency release signal. Preferably, the pilot control valve is in the form of a 3/2-way valve, preferably in the form of a 3/2-way solenoid valve. Preferably, the retention valve is in the form of a 2/2-way valve, preferably a 2/2-way solenoid valve. Preferably, the retention valve is arranged and constructed to maintain the adjusted emergency release pilot control pressure at a main valve control connection of the main valve. In a particularly preferred manner, the electronic emergency release signal includes a first emergency release signal for the pilot control valve and/or a second emergency release signal for the retention valve.

In the context of a further embodiment, there is provision for the emergency release valve unit to be arranged in the parking brake valve unit or to be combined with the parking brake valve unit in order to form a structural unit or to be in the form of an independent emergency release module.

In a second aspect, in order to achieve the objective, the disclosure further sets out a vehicle which has an electropneumatic brake system according to the first aspect of the disclosure, wherein the electropneumatic brake system includes a service brake system. In a further embodiment, the vehicle, preferably the electropneumatic brake system, has an additional control unit for providing the electronic emergency release signal.

In a further embodiment, there is provision for the vehicle to be a tractor arrangement having a towing vehicle which is in the form of a utility vehicle and a trailer, wherein the electropneumatic brake system has a first emergency release valve unit which is associated with a first parking brake valve unit for a towing vehicle parking brake circuit of the towing vehicle and which can be switched in accordance with an electronic vehicle emergency release signal, and a second emergency release valve unit which is associated with a second parking brake valve unit for a trailer parking brake circuit of the trailer and which can be switched in accordance with an electronic trailer emergency release signal. In a particular preferred manner, the electronic vehicle emergency release signal and the electronic trailer emergency release signal are provided by the additional control unit.

In a further embodiment of the vehicle, there is provision for the first parking brake valve unit and the second parking brake valve unit to be in the form of a common, multi-channel parking brake valve unit.

In a third aspect, in order to achieve the objective, the disclosure further sets out a method for operating an electropneumatic brake system which has the steps of: receiving via an emergency release valve unit a service brake pressure which is effective for a service brake braking operation or a pressure which is derived from the service brake pressure; providing an electronic emergency release signal; and receiving the electronic emergency release signal via the emergency release valve unit; providing an emergency release pressure via the emergency release valve unit in accordance with the received electronic emergency release signal, which is effective for at least one spring-loaded brake cylinder; receiving the emergency release pressure via a parking brake valve unit. In a further embodiment of the method, there is provision for the electronic emergency release signal to be provided via an additional control unit. In a further embodiment of the method, there is provision for the additional control unit to be different from a control unit which is associated with the parking brake valve unit. In a further embodiment of the method, there is provision for the service brake pressure or the pressure derived from the service brake pressure or a storage pressure to be provided as an emergency release pressure.

In a fourth aspect, in order to achieve the objective, the disclosure further sets out use of an emergency release valve unit in an electropneumatic brake system, wherein the electropneumatic brake system has a parking brake system having a parking brake valve unit which is constructed to adjust a parking brake pressure on at least one spring loading connection in accordance with a pilot control pressure, wherein the parking brake valve unit has a pilot control unit which in accordance with an electronic parking brake signal adjusts the pilot control pressure at a pilot control path, wherein the parking brake valve unit has an additional brake pressure connection which is or can be pneumatically connected to the pilot control path in order to introduce an emergency release pressure, wherein the introduction of the emergency release pressure at the additional brake pressure connection brings about the adjustment of the parking brake pressure on at least one spring loading connection, and has a first control unit which is constructed to provide the electronic parking brake signal to the parking brake valve unit, wherein the emergency release valve unit receives a service brake pressure which is provided by a service brake system and which is effective for a service brake braking operation or a pressure which is derived from the service brake pressure and in accordance with a received electronic emergency release signal provides an emergency release pressure at the additional brake pressure connection. In a further embodiment of the use, there is provision for the electronic emergency release signal to be provided by an additional control unit.

It should be understood that the electropneumatic brake system according to the first aspect of the disclosure, the vehicle according to the second aspect of the disclosure, the method for operating an electropneumatic brake system according to the third aspect of the disclosure and the use of an emergency release valve unit in an electropneumatic brake system according to the fourth aspect of the disclosure have identical and similar sub-aspects. In this regard, for the further embodiment of an aspect of the disclosure, reference may also be made to the further embodiments of the other aspects of the disclosure.

Preferably, the electropneumatic brake system in the context of the method according to the third aspect of the disclosure and/or in the context of the use according to the fourth aspect of the disclosure is constructed in accordance with at least one of the above-described further embodiments of an electropneumatic brake system according to the first aspect of the disclosure.

### BRIEF DESCRIPTION OF DRAWINGS

The invention will now be described with reference to the drawings wherein:

FIG. 1 shows a vehicle in the form of a utility vehicle with a preferred embodiment of an electropneumatic brake system;

FIG. 2 shows a first embodiment of an emergency release valve unit for an electropneumatic brake system according to the first aspect of the disclosure;

FIG. 3 shows a second embodiment of an emergency release valve unit for an electropneumatic brake system according to the first aspect of the disclosure;

FIG. 4 shows a third embodiment of an emergency release valve unit for an electropneumatic brake system according to the first aspect of the disclosure;

FIG. 5 shows a fourth embodiment of an emergency release valve unit for an electropneumatic brake system according to the first aspect of the disclosure;

FIG. 6 shows a first embodiment of a parking brake valve unit for an electropneumatic brake system according to the first aspect of the disclosure;

FIG. 7 shows a second embodiment of a parking brake valve unit for an electropneumatic brake system according to the first aspect of the disclosure; and,

FIG. 8 shows a vehicle in the form of a tractor arrangement with another preferred embodiment of an electropneumatic brake system.

### DETAILED DESCRIPTION

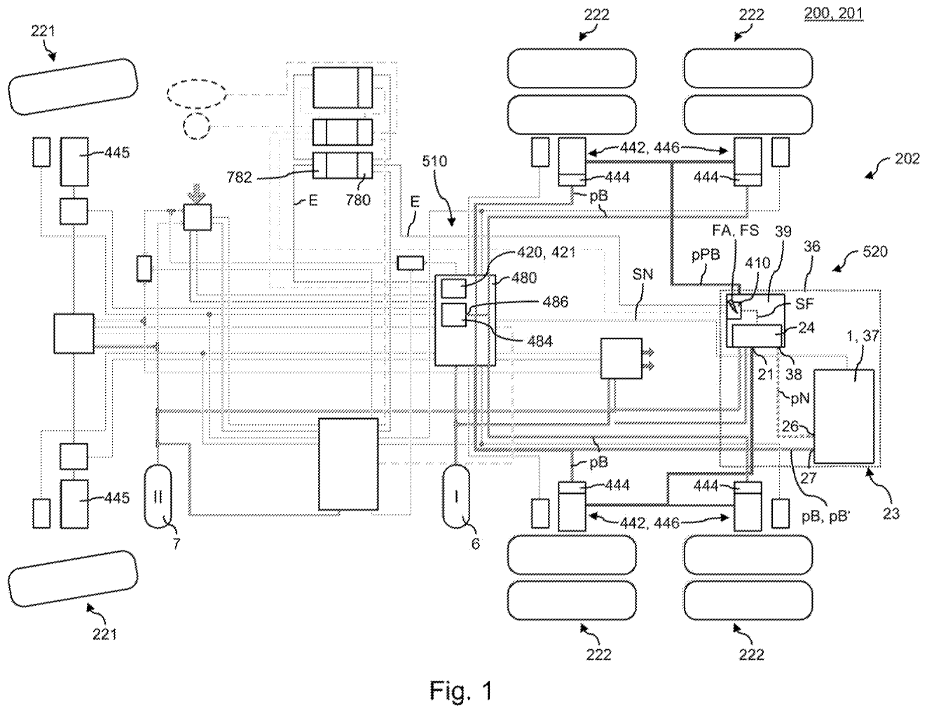

FIG. 1 schematically shows a vehicle 200 in the form of a utility vehicle 201 with a preferred embodiment of an electropneumatic brake system 202. The electropneumatic brake system 202 has a service brake system 510 and a parking brake system 520. The parking brake system 520 has a parking brake valve unit 24 having at least one spring loading connection 21 for providing a parking brake pressure pPB on spring-loaded brake cylinders 442. In this instance, the vehicle 200 has four spring-loaded brake cylinders 442 which are each associated with a rear wheel. Furthermore, the service brake system 510 has two service brake cylinders 445 which are each associated with a front wheel 221.

The spring-loaded brake cylinders 442 are in the form of combination brake cylinders 446, that is, they each have a service brake chamber 444 which is associated with the service brake system 510 and which can be activated via a service brake pressure pB.

In order to receive the service brake pressure pB, the service brake chambers 444 are each pneumatically connected to an operating pressure connection 486 of an axle modulator 484. The electropneumatic brake system 202 has an additional control unit 420 which is in the form of a service brake control unit 421 for controlling the service brake system 510. In this instance, the additional control unit 420 is connected in a signal-guiding manner to the axle modulator 486 for the purposes of activation.

Advantageously, as shown here, the axle modulator 486 and the additional control unit 420 are structurally integrated in a central module 480.

The electropneumatic brake system 202 further has a parking brake valve unit 24 which is constructed to adjust the parking brake pressure pPB. In order to provide the parking brake pressure pPB on the spring-loaded brake cylinder 442, the parking brake valve unit 24 has at least one spring loading connection 21 which is pneumatically connected to the spring-loaded brake cylinders 442.

The electropneumatic brake system 202 has a first control unit 410 which, in order to provide an electronic parking brake signal SF, is connected in a signal-guiding manner to the parking brake valve unit 24 for the purposes of activation.

By the parking brake pressure pPB being adjusted in accordance with the electronic parking brake signal SF at the spring loading connection 21, the spring-loaded brake cylinders 442 are aerated, and a wheel brake which is not illustrated in greater detail here is activated. However, if the spring-loaded brake cylinders 442 are vented, that is, when the parking brake pressure pPB falls below a minimum value, the spring-loaded cylinders 442 are applied and the wheels, in this instance the rear wheels 222, are braked by wheel brakes which are not illustrated in greater detail.

Such a venting of the spring-loaded brake cylinder 442 may be carried out in particular in the event of a braking operation in the event of failure or an emergency braking operation. Such an event occurs, for example, when an exception error FA or a power failure FS is present in the first control unit 410. In such an instance, the vehicle 200 can no longer readily move since the spring-loaded brake cylinders 442 are applied and aeration via the parking brake valve unit 24 is not possible as a result of the failure of the first control unit 410.

A power failure FS is, for example, present when the first control unit 410 is no longer supplied with electrical energy E. In this instance, the first control unit 410 is electrically connected to a first energy supply 780 for the purposes of supply with electrical energy E. In this instance, the additional control unit 420 is electrically connected to a second energy supply 782 for the purposes of supply with electrical energy E.

The electropneumatic brake system 202 has an emergency release valve unit 1. The emergency release valve unit 1 is constructed to provide an emergency release pressure pN at the parking brake valve unit 24.

The emergency release valve unit 1 is pneumatically connected via a main connection 26, on which the emergency release pressure pN is adjusted, to an additional brake pressure connection 386 in the form of an emergency release connection 84 of the parking brake valve unit 24 in order to provide the emergency release pressure pN.

The emergency valve unit 1 is pneumatically connected via a service brake connection 27 to the service brake system 510, in this instance to the axle modulator 480, in order to receive the service brake pressure pB. In other embodiments, the pressure received may be a pressure pB′ which is derived from the service brake pressure pB.

The emergency release valve unit 1 is in this instance connected in a signal-guiding manner to the additional control unit 420 in order to receive an electronic emergency release signal SN.

The parking brake valve unit 24 and the first control unit 410 can, as shown here, be constructed to be structurally integrated as a parking brake module 39.

The emergency release valve unit 1 and the parking brake module 39 may advantageously, as indicated here with broken lines, be constructed to be structurally integrated in a structural unit 36. In alternative embodiments, the emergency release valve unit 1 may be in the form of a structurally independent emergency release module 37.

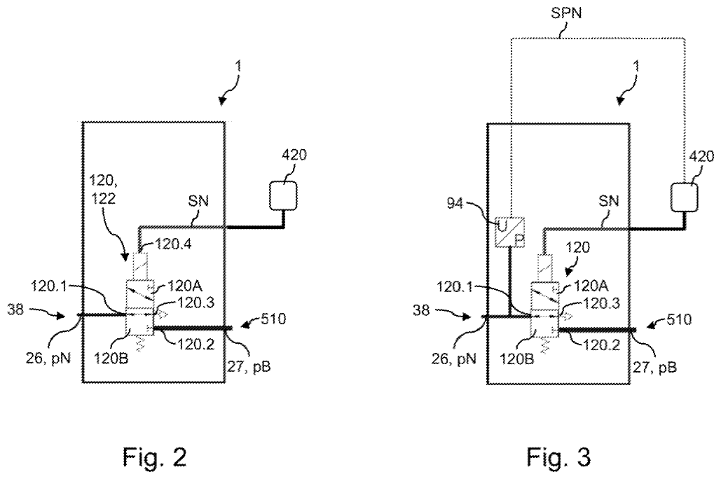

FIG. 2 shows a first emergency release valve unit 1 for a preferred embodiment of an electropneumatic brake system. In this instance, the emergency release valve unit 1 has a 3/2-way valve 120 in the form of a 3/2-way solenoid valve 122. The 3/2-way valve 120 has a first emergency valve connection 120.1, which is pneumatically connected to a main connection 26 in order to provide the emergency release pressure pN. The 3/2-way valve 120 has a second emergency release valve connection 120.2 which, in order to receive the service brake pressure pB or the pressure pB′ derived from the service brake pressure pB, is pneumatically connected to a service brake connection 27. The 3/2-way valve 120 has a third emergency release venting connection 120.3 which vents into an environment. In a first emergency release position 120A of the 3/2-way valve 120, the first emergency release valve connection 120.1 is pneumatically connected to the second emergency release valve connection 120.1 in order to provide a service brake pressure pB′ which is provided at the service brake connection 27 as an emergency release pressure pN at the main connection 26. In a second emergency release valve position 120B, the first emergency release valve connection 120.1 is pneumatically connected to the emergency release venting connection 120.3, in particular in order to vent the main connection 26 and connections which are pneumatically connected thereto.

Via an additional control unit 420 which may be associated with a service brake system 510 which is not illustrated in this instance, an electronic emergency release signal SN may be provided at an electronic control connection 120.4 of the 3/2-way valve 120 in order to switch the 3/2-way valve 120 into the first emergency release valve position 120. In the non-activated state, that is, when there is no electronic emergency release signal SN at the control connection 120.4, the 3/2-way valve 120 is located in the second emergency release valve position 120B.

FIG. 3 shows a second preferred embodiment of an emergency release valve unit 1. In contrast to the first embodiments of the emergency release valve unit 1 as shown in FIG. 2, the second emergency release valve unit 1 has an emergency release pressure sensor 94 which is pneumatically connected to the main connection 26. The emergency release pressure sensor 94 is constructed to establish the emergency release pressure pN which is adjusted at the first emergency release valve connection 120.1 and, depending on the established emergency release pressure pN, to provide a corresponding electronic emergency release pressure signal SPN. In this instance, the emergency release pressure sensor 94 is connected to the additional control unit 420 in a signal-guiding manner in order to provide the electronic emergency release pressure signal SPN to the additional control unit 420.

In embodiments with an emergency release pressure sensor 94, the function of the emergency release valve unit 1, in particular the 3/2-way valve 120, can advantageously be controlled.

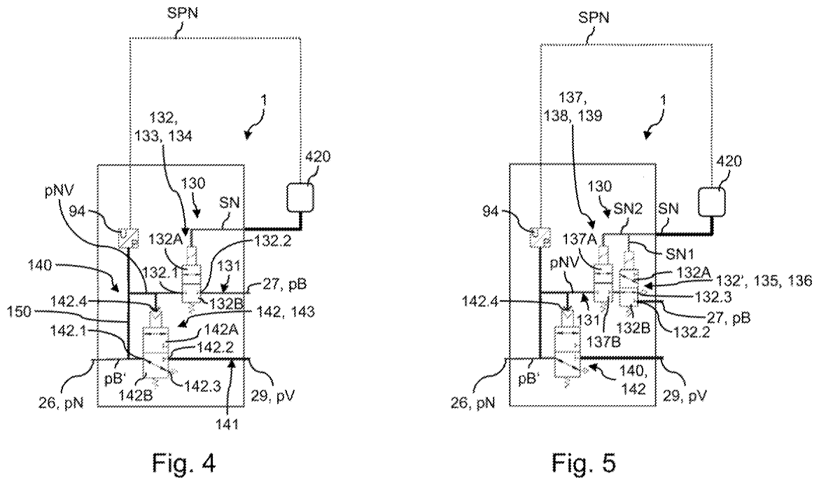

FIG. 4 shows a third preferred embodiment of an emergency release valve unit 1. In contrast to the second embodiment of the emergency release valve unit 1 as shown in FIG. 3, the emergency release valve unit 1 shown in this instance has an emergency release pilot control arrangement 130 and an emergency release main valve arrangement 140. The emergency release pilot control arrangement 130 includes a pilot control valve 132 which is arranged in an emergency release pilot control path 131 and which is in this instance in the form of a 2/2-way valve 133 in the form of a 2/2-way solenoid valve 134. The pilot control valve 132 can be controlled via an electronic emergency release signal SN. The emergency release main valve arrangement 140 includes a pneumatically switchable main valve 142 which is in the form of a 3/2-way valve 143. The pneumatically switchable main valve 142 has a main valve control connection 142.4 which is pneumatically connected to the emergency release pilot control path 131 in order to receive an emergency release pilot control pressure pNV. The pilot control valve 132 is arranged in the emergency release pilot control path 131 between the service brake connection 27 and the main valve control connection 142.4.

In a first valve position 132A of the pilot control valve 132, a second pilot control valve connection 132.2 which is connected to the service brake connection 27 is pneumatically connected to a first pilot control valve connection 132.1 which is connected to the main valve control connection 142.4 in order to provide the service brake pressure pB as an emergency release pilot control pressure pNV at the main valve control connection 142.4. In a second valve position 132B of the pilot control valve 132, the service brake connection 27 is pneumatically separated from the main valve control connection 142.4. The pilot control valve 132 is constructed, depending on the electronic emergency release signal SN, to switch into the first valve position 132A.

The emergency release valve unit 1 additionally has a storage connection 29 for receiving a storage pressure pV.

The emergency release main valve arrangement 140 has a main path 141 which pneumatically connects the storage connection 29 to the main connection 26 and in which the main valve 142 is arranged. The main valve 142 is in this instance in the form of a 3/2-way valve 143. The main valve 142 includes a first main valve connection 142.1 which, in order to provide the emergency release pressure pN, is pneumatically connected to the main connection 26. The main valve 142 includes a second main valve connection 142.2 which in order to receive the storage pressure pV, is pneumatically connected to the storage connection 29. The main valve 142 includes a third main valve venting connection 142.3 which vents into the environment. In a first main-valve valve position 142A of the main valve 142, the first main valve connection 142.1 is pneumatically connected to the second main valve connection 142.2 and preferably the main valve venting connection 142.3 is blocked. In the first main-valve valve position 142A, the storage pressure pV is consequently provided as an emergency release pressure pN at the main connection 26.

In a second main-valve valve position 142B of the main valve 140, the first main valve connection 142.1 is pneumatically connected to the main valve venting connection 142.3 and preferably the second main valve connection 142.2 is blocked. In the second main-valve valve position 142B, the storage connection 29 is consequently pneumatically separated from the main connection 26.

The main valve 142 can be pneumatically controlled via the pilot control valve 132 in such a manner that, when by the pilot control valve 132 in the first valve position 132A thereof, an emergency release pilot control pressure pNV is adjusted at the main valve control connection 142.4, the main valve 142 is switched into the first main valve switching position 142A.

The emergency release valve unit 1 further has a pneumatic self-retaining path 150 which pneumatically connects the first main valve connection 142.1 to the main valve control connection 142.4. Via the pneumatic self-retaining path 150, the emergency release pressure pN which is adjusted at the first main valve connection 142.1 can advantageously be provided as an emergency release pilot control pressure pNV at the main valve control connection 142.4, advantageously independently of the service brake pressure pB which is provided at the service brake connection 27. With a pneumatic self-retaining path 150, it is advantageously possible in the event of a one-time, in particular temporary provision of the service brake pressure pB at the main valve control connection 142.4, to subsequently permanently adjust the emergency release pressure pN at the main connection, even when the service brake pressure pB is no longer provided.

FIG. 5 shows another preferred, fourth embodiment of an emergency release valve unit 1. The emergency release valve unit 1 differs from the emergency release valve unit 1 illustrated in FIG. 4 in that the emergency release pilot control arrangement 130 has another pilot control valve 132′ in the form of a 3/2-way valve 135 and in addition a retention valve 137. The additional pilot control valve 132′ and the retention valve 137 are arranged pneumatically in series in the emergency release pilot control path 131. The additional pilot control valve 132′ is in this instance in the form of a 3/2-way solenoid valve 136 and can be controlled via a first electronic emergency release signal SN1. The additional pilot control valve 132′ has in contrast to the pilot control valve 132 shown in FIG. 4 an additional venting connection 132.3 which in the first valve position 132A is pneumatically connected to the first pilot control valve connection 132.1.

The retention valve 137 is in this instance in the form of a 2/2-way valve 138, that is, in the form of a 2/2-way solenoid valve 139 and can be controlled via a second electronic emergency release signal SN2. The retention valve 137 has a first valve position 137A in which the retention valve 137 is pneumatically open, that is, it pneumatically connects the main valve control connection 142.4 to the pilot control valve 132. The retention valve 137 has a second valve position 137B in which the retention valve 137 pneumatically separates the main valve control connection 142.4 from the pilot control valve 132.

Via the emergency release pilot control arrangement 130 shown here, having a pilot control valve 132 which is in the form of a 3/2-way valve 135 and a retention valve 137, an emergency release pilot control pressure pNV which is applied at the main valve control connection 142.4 can advantageously be vented in a controllable manner in order to end an adjustment of the emergency release pressure pN at the main connection 26. To this end, the retention valve 137 is advantageously switched into the first valve position 137A and the pilot control valve 132 is switched into the second valve position 132B so that the main valve control connection 142.4 is vented via the venting connection 132.3.

Emergency release valve units 1 which are supplied with a storage pressure pV, in particular the third emergency release valve unit 1 shown in FIG. 4 and the fourth emergency release valve unit 1 shown in FIG. 5, advantageously enable a permanent adjustment of an emergency release pressure pN, in particular even when the service brake pressure pB is no longer applied at the service brake connection 27.

According to the emergency release valve units 1 shown in FIG. 4 and FIG. 5, the service brake pressure pB is not provided directly as an emergency release pressure pN but instead a pressure pB′ which is derived from the service brake pressure pB in the form of the storage pressure pV which is provided in accordance with the service brake pressure pB adjusted at the service brake connection 27.

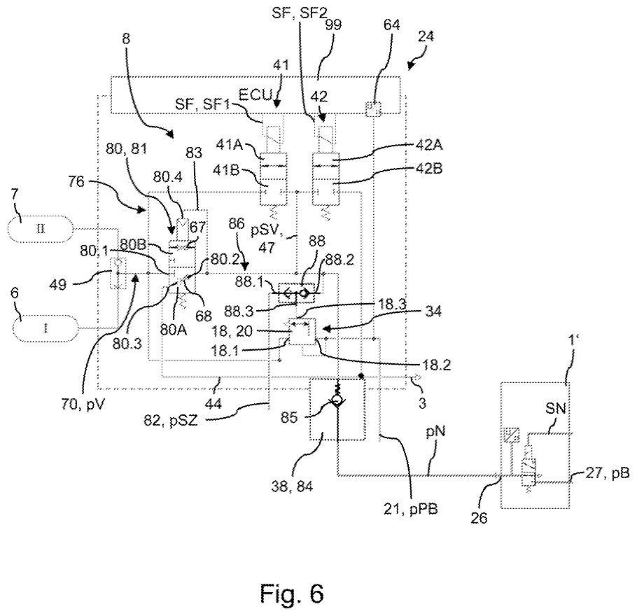

FIG. 6 shows a preferred parking brake valve unit 24 for an electropneumatic brake system 202. An emergency release valve unit 1, in this instance the second embodiment of an emergency release valve unit 1 as shown in FIG. 3, is connected via the main connection 26 thereof in order to provide the emergency release pressure pN to an additional brake pressure connection 38 of the parking brake valve unit 24. The additional brake pressure connection 38 is in this instance in the form of an emergency release connection 84.

The parking brake valve unit 24 has a storage pressure path 70. The parking brake valve unit 24 is constructed, in accordance with an electronic parking brake signal SF, to adjust a parking brake pressure pBP on at least one spring loading connection 21.

The storage pressure path 70, in order to receive a storage pressure pV via a storage shuttle valve 49, is pneumatically connected to a first compressed air store 6 and a second compressed air store 7. The storage shuttle valve 49 is in the form of a select high shuttle valve so that one of the first compressed air store 6 and the second compressed air store 7 is connected to the storage pressure path in which the higher storage pressure pV is applied and the other compressed air store 6 is blocked.

The storage pressure path 70 is divided into a storage branch 74, a control branch 76 and a compensation path 86. The compensation path 86 connects the storage pressure path 70 pneumatically to a pilot control path 47.

A compensation valve 80 is arranged in the compensation path 86. The compensation valve 80 is in the form of a 3/2-way valve 81. The compensation valve 80 has a first compensation valve connection 80.1 which is pneumatically connected to the storage pressure path 70. The compensation valve 80 has a second compensation valve connection 80.2 which is pneumatically connected to the compensation path 86. The compensation valve 80 has a third compensation valve connection 80.3 which is pneumatically connected to a venting line 44. The venting line 44 is connected to a venting connection 3 which vents into the environment.

The compensation valve 80 has a compensation valve control connection 80.4 which is pneumatically connected to the second compensation valve connection 80.2 via a compensation control path 83. Via the compensation control path 83, a pneumatic activation is preferably carried out. Via the compensation control path 83, a pressure which is applied to the second compensation valve connection 80.2, in particular a pilot control pressure pSV, is provided on the compensation valve control connection 80.4.

In a second switching position 80B of the compensation valve 80, the first compensation valve connection 80.1 is pneumatically connected to the second compensation valve connection 80.2, and preferably the third compensation valve connection 80.3 is blocked. In the second switching position 80B, the storage pressure path 70 is consequently pneumatically connected to the compensation path 86 and consequently to the pilot control path 47. In a first switching position 80A of the compensation valve 80, the second compensation valve connection 80.2 is pneumatically connected to the third compensation valve connection 80.3, and preferably the first compensation valve connection 80.1 is blocked. In the first switching position 80A, the compensation path 86 and consequently the pilot control path 47 are pneumatically connected to the venting connection 3.

In this instance, the compensation valve 80 has between the first compensation valve connection 80.1 and the second compensation valve connection 80.2 a first throttle 67. The first throttle 67 advantageously has a nominal width which is smaller in comparison with the compensation path 86 and/or the storage pressure path 70. In this instance, the compensation valve 80 has between the second compensation valve connection 80.2 and the third compensation valve connection 80.3 a second throttle 68. The second throttle 68 advantageously has a nominal width which is smaller in comparison with the compensation path 86 and/or the venting line 44.

When the compensation valve 80 is switched via the compensation control path 83 into the second switching position 80B, via the compensation control path 83 the storage pressure pV is provided at the compensation valve control connection 80.4 in order to retain the compensation valve 80 in the second switching position 80B. In this state, an emergency release pressure pN or pilot control pressure pSV which is introduced once via the additional brake pressure connection 38 and retained by the non-return valve 85 in the pilot control path 47 is retained. If, in the event of leakages in the pilot control path 47, a pressure drop should occur, in a compensating manner the storage pressure pV is tracked via the compensation valve 80, in particular via the throttle 27.

In this instance, the parking brake valve unit 24 has a main valve unit 34. The main valve unit 34 includes a pilot control unit 8 and a pneumatically activated main valve 18. The pilot control unit 8 is constructed, depending on the electronic parking brake signal SF, to provide a pilot control pressure pSV at a control connection 18.3 of the pneumatically activated main valve 18. The pneumatically activated main valve 18 is constructed, depending on this parking brake control pressure pPS, to control the parking brake pressure pBP at a main connection 18.2 which is provided at the spring loading connection 21. The pneumatically activated main valve 18 is in this instance in the form of a relay valve 20.

The pilot control valve 8 has a first pilot control valve 41 and a second pilot control valve 42 which are each in the form of 2/2-way solenoid valves. Via the first pilot control valve 41, in an opening position 41A the storage pressure pV of the storage pressure path 70 can be provided as a pilot control pressure pSV on the pilot control path 47. The pilot control path 47 is arranged between the first pilot control valve 41 and the second pilot control valve 42 and is or can be pneumatically connected to the control connection 18.3 of the main valve 18. Via the second pilot control valve 42, the pilot control pressure pSV can be retained in the pilot control path 47, or the pilot control path 47 can be vented in a controllable manner.

By switching the first pilot control valve 41 into a locking position 41B, the pilot control pressure pSV in the pilot control path 47, in particular at the control connection 18.3, can be captured or retained for permanent activation. In this instance, the second pilot control valve 42 is also in a blocking position 42B. According to the structure of the pilot control unit 8 with a first pilot control valve 41 and a second pilot control valve 42, the electronic parking brake signal SF includes a first electronic parking brake signal SF1 for controlling the first pilot control valve 41 and a second electronic parking brake signal SF2 for controlling the second pilot control valve 42. By switching the second pilot control valve 42 into an opening position 42A, the pilot control path 47 can be pneumatically connected to the venting line 44 in order to vent the control connection 18.3.

The pilot control path 47 can additionally be pneumatically connected to an additional brake pressure connection 38 and/or to an anti-compound connection 82. Via the additional brake pressure connection 38, the emergency brake pressure pN can be provided at the pilot control path 47 and in particular at the control connection 18.3 in order, depending on the pilot control unit 8, to adjust a parking brake pressure pBP on the spring loading connection 21. In particular via the additional brake pressure connection 38 in the event of a failure of the brake system 202 or similar malfunction, which leads to a venting of the spring-loaded brake cylinder 442, a movability of the utility vehicle 201 can be produced in a controlled manner. Advantageously, on the additional brake pressure connection 38, there is arranged a non-return valve 85 which opens in the direction of the control connection 18.3 and blocks in the opposite direction. Via the non-return valve 85, an uncontrolled escape of the pilot control pressure pSV via the additional brake pressure connection 38 can be prevented. Also via the non-return valve 85, an emergency release pressure pN which is introduced once can be permanently captured or retained in the pilot control path 47 in order to permanently aerate the spring loading connection 21 and consequently to release at least one parking brake cylinder.

Via the anti-compound connection 82, an additional parking brake pressure pSZ can be provided at the pilot control path 47 and in particular at the control connection 18.3 in order regardless of the pilot control unit 8 to adjust a parking brake pressure pBP on the spring loading connection 21. In particular, the additional parking brake pressure pSZ can be provided by a service brake function which is not illustrated in this instance in order to produce an anti-compound function.

The electropneumatic valve arrangement 1 further advantageously has a selection valve 88 which is arranged in the pilot control path 47 and which is in the form of a select high valve. The selection valve 88 has a first selection valve connection 88.1 which is connected to the anti-compound connection 82, a second selection valve connection 88.2 which is connected to the additional brake pressure connection 38 and a third selection valve connection 88.3 which is connected to the control connection 18.3. The selection valve 88 is constructed to connect the connection from the first selection valve connection 88.1 and the second selection valve connection 88.2 to the third selection valve connection 88.3 at which the higher pressure is applied.

The electropneumatic valve arrangement 1 has a pressure sensor 64 which is pneumatically connected to the spring loading connection 21 in order to establish the parking brake pressure pBP.

The electropneumatic valve arrangement 1 has an electronic control unit 99 which is connected to the electronic components of the electropneumatic valve arrangement 1 in a signal-guiding and/or energy-conducting manner. In particular in this instance, the first pilot control valve 41 and the second pilot control valve 42 are electrically connected to the electronic control unit 99 for activation. The pressure sensor 64 is also electrically connected to the electronic control unit 99.

Such a parking brake valve unit 24 as illustrated in this instance is in a particularly preferred manner suitable for use with the first emergency release valve unit 1 or the second emergency release valve unit 1 since, as a result of the compensation valve 80, a parking brake pressure pB which is introduced once as an emergency release pressure pN leads to a permanent adjustment of a parking brake pressure pPB on the spring loading connection 21.

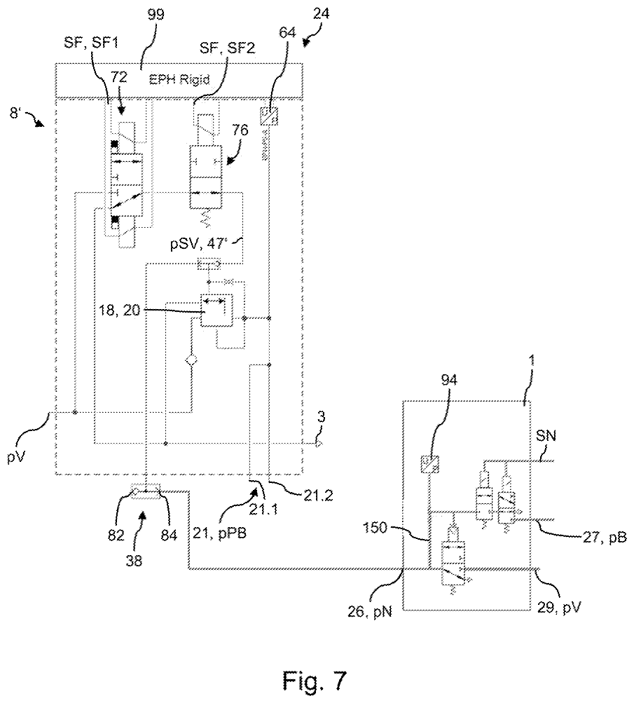

FIG. 7 shows a second parking brake valve unit 24. The second parking brake valve unit 24 has in contrast to the first parking brake valve unit 24 no compensation valve 80 and has an additional pilot control unit 8′ having an additional pilot control path 47′. The additional pilot control path 8′ differs from the pilot control unit 8 shown in FIG. 6 in that it has a bistable valve 72 via which both the aeration and the venting of the additional pilot control path 47′ are carried out. The additional pilot control unit 8′ further has a pilot control retention valve 76 which is pneumatically connected in series to the bistable valve 72 in the remaining pilot control path 47′. Using the pilot control valve 76, the pilot control pressure pSV on the control connection 18.3 of the pneumatically activated main valve 18 can be retained.

The second parking brake valve unit 24 is preferably suitable for use with an emergency release valve unit 1 which enables permanent adjustment of an emergency release pressure pN, in a particularly preferred manner with the third emergency release valve unit 1 or the fourth emergency release valve unit 1. Since the second parking brake valve unit 24 does not have a compensation valve 80 or similar pneumatic retention function, instead an emergency release valve unit 1 having a self-retaining path 150 may advantageously provide this pneumatic retention function.

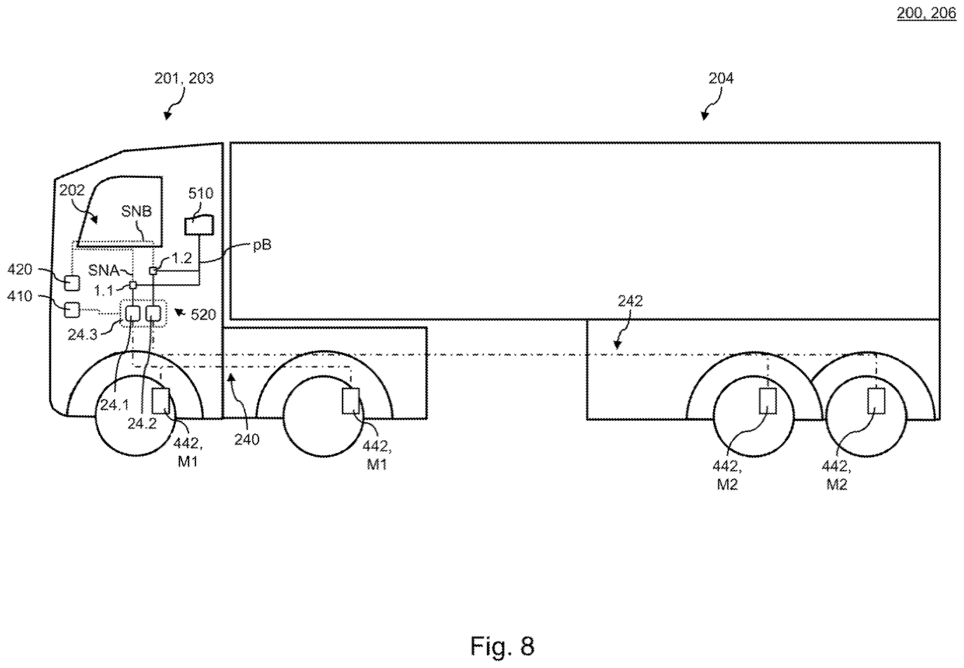

FIG. 8 shows a vehicle 200 in the form of a tractor arrangement 206 having a towing vehicle 203 which is in the form of a utility vehicle 201 and a trailer 204 which is pulled by it.

The vehicle 200 has an electropneumatic brake system 202 according to the disclosure, having a first emergency release valve unit 1.1 which is associated with a first parking brake valve unit 24.1 and a second emergency release valve unit 1.2 which is associated with a second parking brake valve unit 24.2. The first parking brake valve unit 24.1 is associated with a first number M1 of spring-loaded brake cylinders 442 which are arranged in the towing vehicle 203 and which are pneumatically connected thereto via a towing vehicle parking brake circuit 240. The second parking brake valve unit 24.2 is associated with a second number of two spring-loaded brake cylinders 442 which are arranged in the trailer 204 and which are pneumatically connected thereto via a trailer parking brake circuit 242.

The first parking brake valve unit 24.1 and the second parking brake valve unit 24.2 are in each case connected in a signal-guiding manner to a first control unit 410 which is associated with the parking brake system 520.

In preferred embodiments, the first parking brake valve unit 24.1 and the second parking brake valve unit 24.2, as illustrated here with broken lines, is in the form of a common, multi-channel parking brake valve unit 24.3.

The emergency release valve units 1.1, 1.2 are in each case connected in a signal-guiding manner to an additional control unit 420 which in this instance is associated with a service brake system 510. The additional control unit 420 is constructed to provide an electronic vehicle emergency release signal SNA to the first parking brake valve unit 24.1. The additional control unit 420 is further constructed to provide an electronic trailer emergency release signal SNB to the second parking brake valve unit 24.2. As a result of the provision of the electronic vehicle emergency release signal SNA and the electronic trailer emergency release signal SNB, all the spring-loaded brake cylinders 442 can be released and a roadworthy state of the vehicle 200 can be produced.

It is understood that the foregoing description is that of the preferred embodiments of the invention and that various changes and modifications may be made thereto without departing from the spirit and scope of the invention as defined in the appended claims.

### LIST OF REFERENCE NUMERALS (PART OF THE DESCRIPTION)

1 Emergency release valve unit
1.1, 1.2 First, second emergency release valve unit
3 Venting connection
6 First compressed air store
7 Second compressed air store
8, 8′ Pilot control unit
18 Main valve
18.2 Second main connection
18.3 Control connection of the main valve
20 Relay valve
21 Spring loading connection
24 Parking brake valve unit
24.1, 24.2 First, second parking brake valve unit
26 Main connection of the emergency release valve unit
27 Service brake connection of the emergency release valve unit
24.3 Common parking brake valve unit
29 Storage connection of the emergency release valve unit
34 Main valve unit
36 Structural unit
37 Emergency release module
38 Additional brake pressure connection
39 Parking brake module
41 First pilot control valve
41A Opening position of the first pilot control valve
41B Blocking position of the first pilot control valve
42 Second pilot control valve
42A Opening position of the second pilot control valve
42B Blocking position of the second pilot control valve
44 Venting line
47, 47′ Pilot control path
49 Storage shuttle valve
64 Pressure sensor
67 First throttle
68 Second throttle
70 Storage pressure path
72 Bistable valve
74 Storage branch
76 Control branch
80 Compensation valve
80A First switching position of the compensation valve
80B Second switching position of the compensation valve
80.1 First compensation valve connection
80.2 Second compensation valve connection
80.3 Third compensation valve connection
81 3/2-way valve
82 Anti-compound connection
83 Compensation control path
84 Emergency release connection
80.4 Compensation valve control connection
85 Non-return valve
86 Compensation path
88 Selection valve
88.1 First selection valve connection
88.2 Second selection valve connection
88.3 Third selection valve connection
94 Emergency release pressure sensor
99 Electronic control unit
120 3/2-way valve
120A First emergency release valve position of the 3/2-way valve
120B Second emergency release valve position of the 3/2-way valve
120.1 First emergency release valve connection of the 3/2-way valve
120.2 Second emergency release valve connection of the 3/2-way valve
120.3 Emergency release venting connection of the 3/2-way valve
120.4 Control connection of the 3/2-way valve
122 3/2-way solenoid valve
130 Emergency release pilot control arrangement
131 Emergency release pilot control path of the emergency release pilot control arrangement
132 Pilot control valve of the emergency release pilot control arrangement
132A First valve position of the pilot control valve
132B Second valve position of the pilot control valve
132.1 First pilot control valve connection
132.2 Second pilot control valve connection
132.3 Venting connection of the pilot control valve
133 2/2-way valve, pilot control valve in the form of a 2/2-way valve
134 2/2-way solenoid valve, pilot control valve in the form of a 2/2-way solenoid valve
135 3/2-way valve, pilot control valve in the form of a 3/2-way valve
136 3/2-way solenoid valve, pilot control valve in the form of a 3/2-way solenoid valve
137 Retention valve
137A First valve position of the retention valve
137B Second valve position of the retention valve
138 2/2-way valve, retention valve in the form of a 2/2-way valve
139 2/2-way solenoid valve, retention valve in the form of a 2/2-way solenoid valve
140 Emergency release main valve arrangement
141 Main path of the emergency release main valve arrangement
142 Main valve of the emergency release main valve arrangement
142A First main-valve valve position
142B Second main-valve valve position
142.1 First main valve connection
142.2 Second main valve connection
142.3 Main valve venting connection
142.4 Main valve control connection
143 3/2-way valve, main valve in the form of a 3/2-way valve
150 Self-retaining path, self-retaining path of the emergency release main valve arrangement
200 Vehicle
201 Utility vehicle
202 Electropneumatic brake system
203 Towing vehicle
204 Trailer
206 Tractor arrangement
221 Front wheel
222 Rear wheel
240 Traction vehicle parking brake circuit
242 Trailer parking brake circuit
410 First control unit
420 Additional control unit
421 Service brake control unit
442 Spring-loaded brake cylinder
444 Service brake chamber
445 Service brake cylinder
446 Combination brake cylinder
480 Central module
484 Axle modulator
486 Service brake pressure connection
510 Service brake system
520 Parking brake system
780 First energy supply
782 Second energy supply
E Energy
FA Exception error
FS Power failure
M1, M2 First, second number of spring-loaded brake cylinders
pB Service brake pressure
PN Emergency release pressure
PNV Emergency release pilot control pressure
pPB Parking brake pressure
PSV Pilot control pressure
PSZ Additional parking brake pressure
PV Storage pressure
S Vehicle emergency release signal
SF Electronic parking brake signal
SF1, SF2 First, second electronic parking brake signal
SN Electronic emergency release signal
SN1, SN2 First, second electronic emergency release signal
SNA Vehicle emergency release signal
SNB Trailer emergency release signal
SPN Emergency release pressure signal

1. An electropneumatic brake system for a vehicle, the electropneumatic brake system comprising:
a parking brake system having a parking brake valve unit configured to adjust a parking brake pressure on at least one spring loading connection in dependence upon a pilot control pressure;
said parking brake valve unit having a pilot control unit configured to, in dependence upon an electronic parking brake signal, adjust the pilot control pressure on a pilot control path;
said parking brake valve unit having an additional brake pressure connection pneumatically connected or connectable to said pilot control path in order to introduce an emergency release pressure, wherein the introduction of said emergency release pressure on said additional brake pressure connection brings about the adjustment of said parking brake pressure on said at least one spring loading connection;
a first control unit configured to provide said electronic parking brake signal to said parking brake valve unit; and,
an emergency release valve unit configured to receive a service brake pressure provided by a service brake system and effective for an operating braking operation or a pressure derived from said service brake pressure and in dependence upon a received electronic emergency release signal, to provide an emergency release pressure to said additional brake pressure connection.

2. The electropneumatic brake system of claim 1 further comprising an additional control unit configured to provide said electronic emergency release signal.

3. The electropneumatic brake system of claim 2, wherein said additional control unit is a service brake control unit associated with said service brake system.

4. The electropneumatic brake system of claim 2, wherein said first control unit is supplied with electrical energy from a first energy supply and said additional control unit is supplied with electrical energy from a second energy supply independent of said first energy supply.

5. The electropneumatic brake system of claim 1 further comprising an emergency release pressure sensor configured to establish said emergency release pressure provided by said emergency release valve unit.

6. The electropneumatic brake system of claim 1, wherein said pilot control unit is configured to be pneumatically self-retaining.

7. The electropneumatic brake system of claim 1, wherein:
said emergency release valve unit has a 3/2-way valve having a first emergency release valve connection for providing said emergency release pressure, a second emergency release valve connection for receiving said service brake pressure or said pressure derived from said service brake pressure and a third emergency release venting connection; and,
said 3/2-way valve in a first emergency release valve position pneumatically connects said first emergency release valve connection to said second emergency release valve connection and in a second emergency release valve position pneumatically connects said first emergency release valve connection to said third emergency release venting connection.

8. The electropneumatic brake system of claim 1 further comprising:
an emergency release main valve arrangement;
said emergency release valve unit having an emergency release pilot control arrangement which in dependence upon said electronic emergency release signal adjusts said service brake pressure or said pressure derived from said service brake pressure as an emergency release pilot control pressure; and,
said emergency release main valve arrangement having a pneumatically switchable main valve configured to adjust a storage pressure as said emergency release pressure at a main connection in dependence upon said emergency release pilot control pressure.

9. The electropneumatic brake system of claim 8, wherein said emergency release valve unit has a pneumatic self-retaining path which pneumatically connects a main valve control connection of said main valve to at least one of said main connection and a first main valve connection of said main valve.

10. The electropneumatic brake system of claim 8, wherein said emergency release pilot control arrangement has a pilot control valve configured to be controlled via said electronic emergency release signal.

11. The electropneumatic brake system of claim 8, wherein said emergency release pilot control arrangement has a retention valve configured to selectively retain said emergency release pilot control pressure in dependence upon said emergency release signal.

12. The electropneumatic brake system of claim 1, wherein said emergency release valve unit is arranged in said parking brake valve unit or is combined with said parking brake valve unit to form a structural unit or is an independent emergency release module.

13. The electropneumatic brake system of claim 1, wherein the vehicle is a utility vehicle.

14. The electropneumatic brake system of claim 7, wherein said 3/2-way valve is a 3/2-way solenoid valve.

15. A vehicle comprising:
a service brake system;
an electropneumatic brake system having a parking brake system, a first control unit, and an emergency release valve unit;
said parking brake system having a parking brake valve unit configured to adjust a parking brake pressure on at least one spring loading connection in dependence upon a pilot control pressure;
said parking brake valve unit having a pilot control unit configured to, in dependence upon an electronic parking brake signal, adjust the pilot control pressure on a pilot control path;
said parking brake valve unit having an additional brake pressure connection pneumatically connected or connectable to said pilot control path in order to introduce an emergency release pressure, wherein the introduction of said emergency release pressure on said additional brake pressure connection brings about the adjustment of said parking brake pressure on said at least one spring loading connection;
said first control unit being configured to provide said electronic parking brake signal to said parking brake valve unit; and,
said emergency release valve unit being configured to receive a service brake pressure provided by said service brake system and effective for an operating braking operation or a pressure derived from said service brake pressure and in dependence upon a received electronic emergency release signal, to provide an emergency release pressure to said additional brake pressure connection.

16. The vehicle of claim 15, wherein:
the vehicle is a tractor arrangement having a towing vehicle configured as a utility vehicle and a trailer; and,
said electropneumatic brake system has a first emergency release valve unit associated with a first parking brake valve unit for a towing vehicle parking brake circuit of the towing vehicle and configured to be switched in dependence upon an electronic vehicle emergency release signal and further has a second emergency release valve unit associated with a second parking brake valve unit for a trailer parking brake circuit of the trailer and is configured to be switched in dependence upon an electronic trailer emergency release signal.

17. The vehicle of claim 15, wherein the vehicle is a utility vehicle.

18. A method for operating an electropneumatic brake system having an emergency release valve unit, the method comprising:
receiving via the emergency release valve unit a service brake pressure which is effective for an operating braking operation or a pressure derived from the service brake pressure;
providing an electronic emergency release signal;
receiving the electronic emergency release signal via the emergency release valve unit;
providing an emergency release pressure via the emergency release valve unit in dependence upon the received electronic emergency release signal which is effective for at least one spring-loaded brake cylinder; and,
receiving the emergency release pressure via the parking brake valve unit.
